(19) United States
(12) Patent Application Publication
(10) Pub. No.: US 2008/0118767 A1
(43) Pub. Date: May 22, 2008

(54) Material for Vapor Sources of Alkali and Alkaline Earth Metals and a Method of its Production

(76) Inventor: Konstantin Chuntonov, Klagenfurt (AT)

Correspondence Address: NEXSEN PRUET, LLC, P.O. BOX 10648, GREENVILLE, SC, 29603, US

(21) Appl. No.: 11/661,016

(22) PCT Filed: Aug. 22, 2005
(86) PCT No.: PCT/EP05/09060

§ 371 Date: Sep. 17, 2007

(30) Foreign Application Priority Data
Aug. 23, 2004 (EP) EP2004/51880

(51) Int. Cl. B32B 15/01; B05D 3/00

(52) U.S. Cl. 428/570; 427/216

(57) ABSTRACT

The present invention relates to a method of production of a new material, consisting of a) a leaching of component A from the surface of particles of the composition AₙGaₘ upon exposure to hot water on a special support b) solidification of the cover layer of gallium metal in ice-cold water, and c) passivation of the gallium surface layer of the particles in streams of pure water and air.

The product has the form of singular particles of monocrystalline intermetallic compounds of the general formula AₙGaₘ with a continuous gallium surface coating for usage in evaporators of metal A, where A is an alkali or alkaline earth metal. The average diameter of the particles is in the range from about 0.2 mm to about 3.5 mm, the gallium coating is thicker than 10 μm.

### BACKGROUND OF THE INVENTION

1. Field of the Invention

The present invention relates to the technology of the creation of anticorrosive coatings on extremely sensitive metal particles, specifically introducing an efficient industrial method of encapsulation of intermetallic particles AₙGaₘ, where A is an alkali or alkaline earth metal and n and m are indices. The chemically active material according to the present invention can be used as vapor source of alkali and alkaline earth metals in the production of photoemission devices, in the production of organic light emitting diodes, in the production of film chemisorbents.

2. Description of Background of Information

Particles of intermetallic compounds of the general formula AₙGaₘ, where A is an alkaline or an alkaline earth metal and m and n are stoichometric indices, when covered by a shell of gallium metal, can be used as convenient sources of the metal A component in a variety of vacuum technologies for producing thin films of metal A (see Chuntonov K. A., Postovalov V. G., Kesarev A. G. Vacuum 55 (1999) pages 101-107). For the first time a method of creating inert metallic layers on the surface of chemically active intermetallic compounds was developed for the gallides of alkali metals (RU 2056661 C 1). This concept was later generalized and spread to the whole class of AₙMeₘ type compounds containing fusible and insensitive metals like Ga, In, Sn, etc. as Me, and alkali, alkaline earth or rare-earth metals as A (WO 03/031100).

The fundamental difference between the methodology described in RU 2056661 C 1 and WO 03/031100 described in the prior art is the concept that the material necessary for the formation of a cover layer is not deposited from outside sources, but is drawn from the intrinsic resource of the treated substance, i.e. from a component of the intermetallic compound. According to the new method, a particle AₙMeₘ is immersed in a special liquid extractant L at a temperature T>T_{f}, where T_{f} is the melting point of the pure metal Me. The active component A dissolves in L, leaving an excess of the second component Me on a particle surface which turns into a continuous film of metal Me in the form of a melt. As the temperature of L is decreased to T<T_{f}, the Me film solidifies reliably insulating the sensitive intermetallic core material of the particle against the environment.

The thickness of the coating Me is determined by the leaching time, and the choice of the extractant L is determined by the melting point of the metal Me and the requirement of efficient wetting of the crystal AₙMeₘ with its cover of melted metal Me in the presence of L. For the production of a Ga-coating, water can serve as an extractant (RU 2056661 C 1) owing to its suitable physical constants. For In- or Sn-coatings, organic extractants with higher temperature boundaries for the liquid state must be used, e.g. polyatomic alcohols, carboxylic acids, etc. (WO 03/031100).

The extraction method of encapsulation of intermetallic particles AₙMeₘ in the form suggested by the prior art (RU 2056661 C 1 or WO 03/031100) works satisfactorily at a laboratory scale but is not suitable for industrial usage because it requires voluminous equipment and gives low yields of high quality product.

The main detrimental aspect is the high tendency of as-encapsulated particles to conglutination. As experience has demonstrated, the mass which is collected in the receiver of the extraction column is far from uniform: only a small part of the product consists of separately encapsulated particles, whereas the major part must be described as agglomerates of conglutinated particles containing residues of the extractant L in their voids. Removal of these residues of the extractant L and its reaction byproducts (metal hydroxides, alkoxides, carboxylates etc.) from such a material is not an easy task as any attempts to separate the conglutinated particles either mechanically or chemically lead to damage of the protective shell of the particles.

Another drawback of the prior art is the large size of the extraction equipment. Thus, the characteristic reaction time for producing a satisfactory gallium coating on the intermetallic surface of a particle takes about two minutes. Experiments of the inventor of the present invention have shown that for the encapsulation of, e.g., AₙMeₘ particles with a diameter in the range from about 1 mm to 2 mm with an average sinking rate in hot water of about 10⁻¹ m/s, the height only of the hot zone of the extraction column must be not less than 12 m.

Finally, the unacceptable quality of the product obtained following the technology of prior methods (RU 2056661 C 1) and (WO 03/031100) is also caused by variations in the structure of the initial materials. In particular, it was noticed that a polycrystalline structure of the particles is unfavourable for efficient encapsulation: during the leaching process any granules with needle or laminar structures melt into a spherical shape; this process proceeds very fast and leads to an unacceptable loss of the active component A. Quite generally, the extractant penetrates along the grain boundaries of the polycrystallites into the particle and is immured there after the formation of the outside shell, contaminating the particle.

Even mono crystalline particles grown from a melt with an excess of component A have been observed to perform badly as vapor sources, because they may contain micro inclusions of metal A. On heating in a vacuum such particles are found to explode yielding to the inner vapor pressure of metal A, which leads to a scattering of particle fragments in the vacuum chamber and to oscillations of the vapor flow rate.

### SUMMARY OF THE INVENTION

The present inventor conducted experiments and showed that the disadvantages of the extraction method in its prior variants can be overcome with the help of new solutions based on a) using a pre-floatation state of the intermetallic particles while it reacts with water, b) the phenomenon of self-passivation of the coating metal when it is subjected to a controlled exposure to water and air, and c) observing strict requirements regarding the microstructure of the initial particles and considering their structure on the molecular level.

For this purpose, a new encapsulation technology which can be carried out in two variants, a conveyor and a cassette methodology, has been developed as applied specifically to AnGam particles. As compared to other compounds of the type AₙMeₘ, the gallides provide a particularly high grade of purity. An unprecedented quality of the particles prepared by the new method is guaranteed by carefully selecting the starting material, by keeping the particles isolated from each other prior to passivation, and by a sequence of process steps which e.g. make any cleaning of the metallic particles from residues of organic extractants, such as from stearic acid or glycerol (WO 03/031100) unnecessary. In total, the process is also not only yielding a better product and is more economical, but also environmentally benign because it uses no solvents other than water.

It is thus an object of the present invention to provide a method for the production of protective coatings on the surface of chemically active materials according to which not only a better product is yielded but where the processes are also more economical and environmentally beneficial.

Another object of the present invention is to provide chemically active materials, which are especially qualified as perfect vapor sources of alkali and alkaline earth metals.

The above-stated objects of the invention can be attained by a process for the production of monocrystalline binary intermetallic compounds defined by the general formula AₙGaₘ with 0<n≦22 and 0<m≦39, wherein n and m are indices and wherein compound A is a metal and is selected from the group consisting of lithium, sodium, potassium, rubidium, cesium, calcium, strontium, barium and radium, comprising the steps of a) leaching of single crystals of the compound of said formula AₙGaₘ in water, which dissolves metal A, but which cannot dissolve gallium, at a temperature which is higher than the melting point of gallium, to produce a melted cover layer consisting essentially of gallium metal b) terminating the treatment as soon as the desired thickness of the coating is reached, c) solidification of the cover layer made of gallium metal, and d) passivation of the gallium cover layer of the particles.

According to another embodiment of the present invention the monocrystalline binary intermetallic compounds are defined by the general formula AₙGaₘ with 1≦n 22 and 2≦m≦39, wherein n and m are stoichometric indices from a natural sequence (positive integers) n=1, 2, 3, 4 . . . ; m=1, 2, 3, 4 . . . , and wherein compound A is a metal and is selected from the group consisting of lithium, sodium, potassium, rubidium, cesium, calcium, strontium, barium and radium.

According to the invention said steps a), b), c) and d) are carried out with individual particles isolated from each other to prevent any aggregation. Leaching according to step a) of the compound of the formula AₙGaₘ is carried out on a support, especially a mesh made of metal. The termination of the treatment in step b) is reached by lowering the temperature below the melting point of gallium metal. The preferred thickness of the gallium coating is 10 μm, the average diameter of the AₙGaₘ particles is in the range from 0.2 mm to 3.5 mm. The mono crystalline particles of the formula AₙGaₘ, grown from a stoichometric melt or from a melt with a small excess of gallium, are used as the initial material, the monocrystals of the compound AₙGaₘ being chosen from the group consisting of LiGa, NaGa₄, Na₂₂Ga₃₉, KGa₃, RbGa₃, CsGa₃, Cs₈Ga ₁, CaGa₄, Ca₃Ga_{g}, SrGa₄, SrGa₂ and BaGa₄.

According to one embodiment of the invention in the beginning a particle is exposed to hot water on a slowly rotating horizontal mesh, whereafter the particle is thrown down into a small extraction column where in the lower cold part of the column the melted gallium-shell solidifies (step c) and the particles get on to a conveyor belt moving the particles to air followed by a rinsing of the product and rapid passivation of the gallium surface layer of the particles according to (step d) is carried out in streams of water and/or air including drying of the particles with an air-flow.

According to another embodiment of the invention, in step a) a metallic sieve divided into a large number of cells is employed to carry the AₙGaₘ particles, which after loading with particles is placed into an extraction tank and exposed to water for the set time, and wherein hot water is subsequently displaced by cold water from below by feeding it upwards through a damping mesh and creating a hydrodynamic backing, which induces crystallisation of a gallium shell under noncontact conditions when a particle is in a suspension state, and wherein passivation of the created gallium shell by intensive rinsing of particles with distilled water and blowing with dustfree atmospheric air is conducted.

The above stated object of the invention can also be attained by the chemically active material comprising the protective coating on their surface obtainable by the above explained process with steps a) to d).

The chemically active material according to the present invention can be used as vapor source of alkali and alkaline earth metals in the production of photoemission devices and in the production of organic light emitting diodes, as chemisorbent including getters for vaporable and nonvaporable substrates, in the production of gas filters and sealed vacuum apparatus, for use as a source for active metals in chemical synthesis in the form of a catalyst or as a reaction component to produce chemicals and alloys, as well as in supplementation pumps and/or particle accelerators.

The main advantages of the specific form of the material according to the invention and the methods of their preparation are: a) a significant improvement of the quality of the vapor source particles; b) compact and efficient equipment; und c) a multiple increase of the production capacity.

A radical change in the technological concept of the extraction method according to RU 2056661 C 1, as a result of which it turns from a laboratory method into an industrial method of manufacturing encapsulated granules of the formula AₙGaₘ, arises from three innovations: regulation of the quality of the initial intermetallic particles, leaching on a metallic mesh as a support, and rapid passivation of the solid coating on separated particles.

The inventor of the present invention found that the extraction method according to the present invention offers high reproducibility in the properties of encapsulated particles and the required purity of the product then and only then, when monocrystalline AₙGaₘ particles (single crystals), grown from a melt of a strictly stoichiometric composition or from a melt with a small excess of gallium, are used as the initial material.

The requirement of monocrystallinity of the initial AₙGaₘ particles as a necessary condition to guarantee purity and stability of parameters of the end product is formulated with reference to the extraction method for the first time and is a priority requirement for the new modification of this method. As far as it is easier to grow monocrystals of congruently melting compounds or peritectic phases with a wide concentration interval for crystallization, further on under the general formula AₙGaₘ we understand intermetallic compounds of this very type. According to the data on phase diagrams they include the following gallides: LiGa, NaGa₄, Na₂₂Ga₃₉, KGa₃, RbGa₃, CsGa₃, Cs₈Ga₁₁, CaGa₄, Ca₃Ga_{g}, SrGa₄, SrGa₂ and BaGa₄.

According to the present invention is shall be understood that the material used for the mono crystalline AₙGaₘ particles can contain impurities of up to 3 atomic percent of base metals including iron, nickel, molybdenum, tungsten, chromium and titanium.

X-ray diffraction analysis of particles can serve as a convenient means of initial material quality control. An example of such control is given in FIGS. 7 and 8 and also in FIGS. 9a, 9b, 10a, and 10b, showing morphology of crystal LiGa and Cs_{g}Ga₁₁ correspondingly.

The second important step in the technological improvement of the process consists in the replacement of bulky extraction columns by small baths containing metallic mesh devices serving as a support for the particles. On this support, a jacket of gas bubbles surrounding the particle which reacts with water, shields this particle from contacts with the mesh (FIG. 1). That is, an AₙGaₘ particle placed in hot water on a metallic mesh behaves in the same way as in the absence of the mesh, “does not feel” it, and by exploiting this condition it becomes possible to simplify the whole extraction equipment and reduce it in size as illustrated below.

However, the effect of the bubble jacket depends on the particle size: for particles smaller than 0.2 mm the tendency to floating-up is strong, while for particles larger than about 3.5 mm partial extrusion of gallium melt from under a particle and the appearance of coating defects is observed. The optimum size for encapsulation of the particles (related to the ratio of gravity force to buoyant force) was found to be in the range from about 0.2 mm to about 3.5 mm. This range determines properly the borders of mesh applicability in the extraction method.

The exposure of AₙGaₘ particles to hot water on metallic mesh thus also allows obtaining continuous gallium coating and is an alternative to extraction columns without support. At this, the new solution reduces the dimensions of the extraction equipment by a large factor and lowers the production cost.

Finally, one more of the serious drawbacks of the prior art RU 2056661 eland WO 03/031100, vie. the conglutination and formation of agglomerates of coated particles, has been overcome by including a controlled treatment of the particles with water and air immediately after solidification of their gallium shell. The tendency of the particles to conglutinate, caused by the very high purity of the as-formed gallium surface with its low melting point is lost in only a few minutes in the process of absorption by this surface of oxygen and other heteroatoms from water and air. Accordingly, in the treatment of the particles while they are kept separate, passivation of the solidified gallium coating is accomplished and the particles lose their ability to adhere to each other.

Also the drawback of the previous methods (RU 2056661 and WO 03/031100) is that contamination of the product inevitably took place at the stage of encapsulation: penetration of an extractant into the volume of the particle along the grain boundaries during leaching and immurement of the extractant during conglutination of the gallium coated particles while they are collected in a receiver of the technological column.

The method according to the present invention eliminates the mentioned drawback due to the usage of monocrystalline particles and due to the passivation of the gallium coating, which eliminates the ability of the particles to conglutinate. Also the isolated treatment of the particles under conditions of the absence of contact between them provides very high yield of the end product.

So the method according to the present invention provides a practical solution for the problem of production of chemically active materials with guaranteed high purity and this method for the first time allows manufacturing this kind of materials on an industrial scale.

Taking into consideration the concepts presented above and recent experimental observations, two technological solutions have been designed for organizing the encapsulation process, comprising the form of a conveyor line and an apparatus of periodic action.

The conveyer-variant: The process of leaching and formation of a protective coating is performed in the following way. In the beginning, a particle is exposed to hot water on a slowly rotating horizontal mesh (FIG. 2). Subsequently, the particle is thrown into a small extraction column, in the lower, cold part of which the melted shell of gallium metal solidifies, and the particle is then placed onto a moving conveyer belt, which exposes it to the air and subjects it to a series of operations of rinsing and air passivation of the coating, including finally drying of the particle in a stream of air.

In summary, the conveyer variant is characterized by a continuous motion of the treated particles one by one in certain intervals, and their sequential transfer from one technological zone to the other. In each of the zones a set of conditional parameters is maintained.

The cassette-variant: Unlike in the previous case, in this variant a large number of particles, isolated from each other, simultaneously and at once undergo a sequence of states, which constitutes the essence of the encapsulation process. The change of the states occurs by changing the parameters of the media into which the treated particles are placed.

A metallic sieve divided into a large number of cells, one particle in each, is put into a tank with hot water for a set time. Then, the hot water is displaced by cold water from below (FIG. 5). The cold water is fed upwards through a damping mesh and is creating a hydrodynamic backing allowing crystallization of the gallium shell of the particles under non-contact conditions with the particle in a suspension state.

Subsequently, the remains of the alkaline solution are removed and the passivation process of the cover layer of the particles is started. For this the particles are rinsed and dried with a fan, the procedure being repeated several times.

Summarizing the short descriptions, both variants are based on the same set and sequence of technological stages:
leaching of an active component A from the surface of a monocrystalline particle and formation of a molten gallium coating;
crystallisation of this coating either at immersing the particle into cold water under the influence of gravitation forces, or while the particle is in a suspension state in upward water flows;
passivation of the as-created shell of gallium metal by extensive rinsing of the particles with distilled water and blowing with dust-free atmospheric air.

Elements of principal novelty of the technology are:

introduction of a standard for the materials which enter the treatment, requmng mono crystallinity of the AₙGaₘ particles and limitation of their average linear size to the range between 0.2 mm and 3.5 mm;
a process of leaching of component A generating a melted gallium coating on the AₙGaₘ particles by exposing them to hot water on a metallic mesh;
crystallisation of the gallium coating under contactless conditions under cold water fed through a mesh from below upwards;
an independent operation of passivation of the solidified gallium coating with the help of rinsing the particles while they are separated from each other with water and exposing them to a stream of air.

The new technology and the new products have the following advantages:
the new material in a form of monocrystalline particles of AₙGaₘ with a gallium coating is characterized by higher chemical purity and stability of physical parameters than previous products;
consequently, the new material is a vapor source for metal A of higher, unprecedented quality;
the new technology is more perfect and simple, it allows increasing the yield of the product per time unit by a large factor and to increase the capacity of the extraction method to an industrial level.
the new material according to the present invention can be used in the production of thin films by vacuum deposition. Especially it can be used in the production of photoemission devices, in the production of organic light emitting diodes and in the production of film chemisorbents.

### BRIEF DESCRIPTION OF THE DRAWINGS

FIG. 1 shows a particle of AₙGaₘ in hot water on a metal mesh support.

FIG. 2 is a general plan view of the conveyer line.

FIG. 2a is a section along line A-A.

FIG. 2b is an expansion of the section along line A-A.

FIG. 3 is a longitudinal section of the apparatus.

FIG. 4 is a scheme of rinsing and drying.

FIG. 5 is an apparatus for the cassette method.

FIG. 6 shows the upper part of the extraction apparatus (see also 1-9 in FIG. 2)

FIG. 7 shows the single crystal X-ray diffraction pattern of LiGa (cubic).

FIG. 8 shows single crystal X-ray diffraction pattern of Cs₈Ga₁₁ (rhombohedral).

FIG. 9a, 9b show single crystals of LiGa in which the agglomerate (before crushing) clearly shows the cubic symmetry of the individual crystal.

FIG. 10a, 10b show single crystals of Cs₈Ga₁₁.

### DETAILED DESCRIPTION OF THE PREFERRED EMBODIMENTS

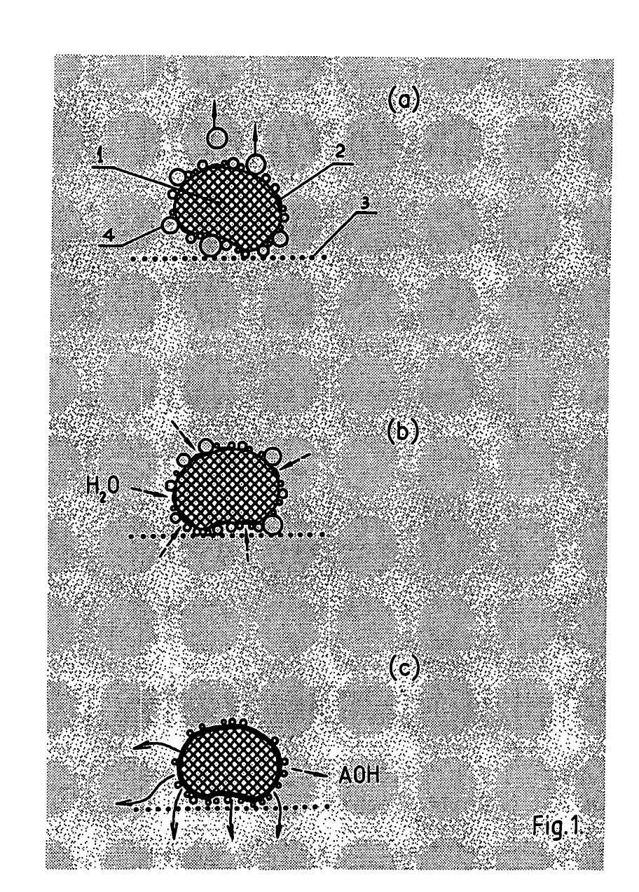

A particle of AₙGaₘ in hot water on a metal mesh support is shown in FIG. 1a, wherein A—intermetallic core, B—an island of molten Ga on a particle surface, C—stainless steel mesh, D—hydrogen bubbles;

b) shows free access for water to the entire particle surface; and

c) shows free outlet of the products of dissolution of metal A in H₂O from the particle surface.

Initially, the leaching reaction proceeds most vigorously (FIG. 1a) with strong gas release. As the islands of gallium metal on the surface increase (FIG. 1b) the fraction of unreacted surface becomes smaller and accordingly the kinetics of gas release decreases. At the final stage of the process (FIG. 1c) the entire particle surface is covered with a layer of melted gallium metal and the reaction changes to the diffusion-controlled regime.

First embodiment according to the present invention: The conveyer variant

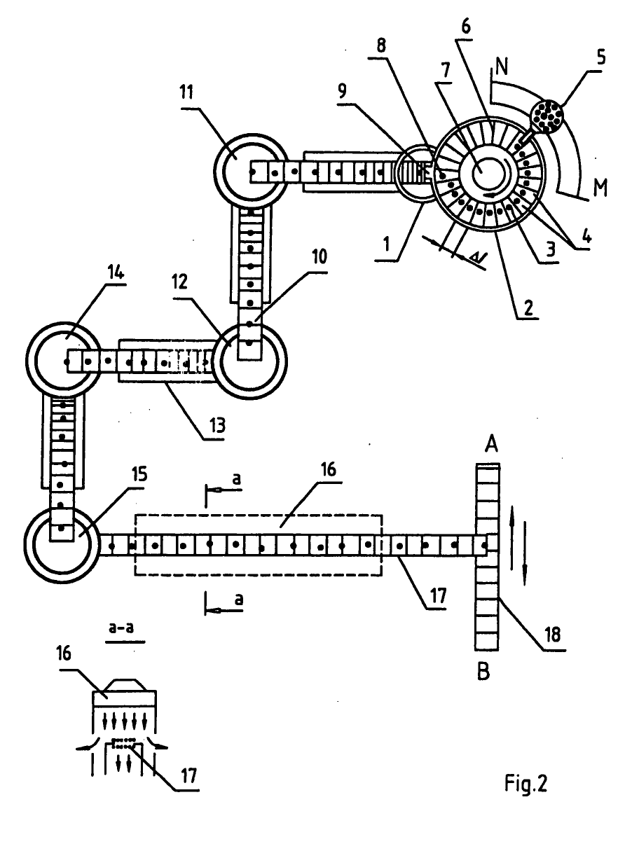

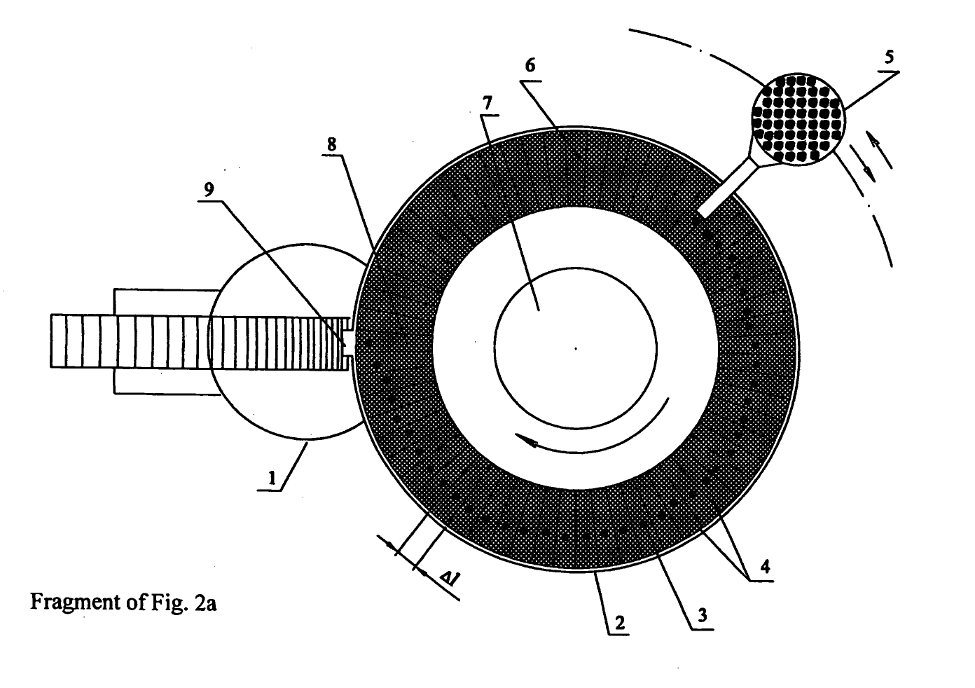

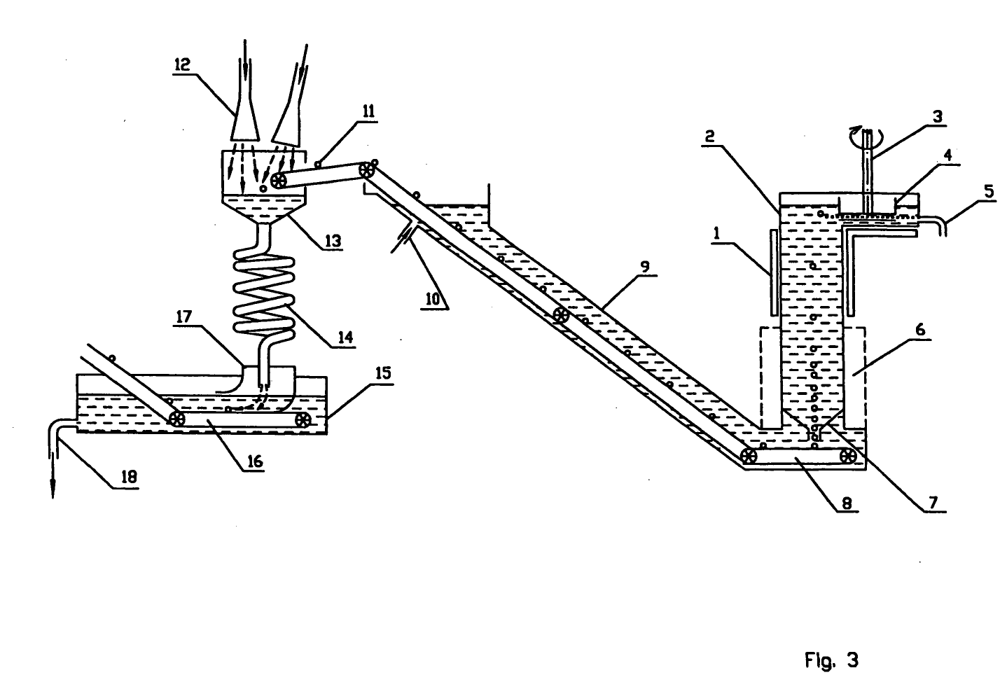

The extraction column 1 and a cylindrical bath 2, in which a mesh disk 4 is placed, represent the complete reservoir (FIG. 2) wherein 1—an extraction column, 2—an extraction bath; 3—a particle in a cell, 4—two abutting cells of a mesh disk; 5—a doser; 6—a radial partition; 7—a stepper motor; 8—a cell open for throwing a particle down into the column; 9—a doorway in a side wall of the bath; 10—a conveyer belt (see also 16 in FIG. 3); 11—a receiving funnel of the first rinsing basin (corresponding to funnel 13 in FIG. 3); 12—the second funnel; 13—a conduit for the conveyer belt (see also 15 in FIG. 3); 14—the third funnel; 15—the fourth funnel; 16—an air fan with a filter; 17—a mesh conveyer belt; 18—a packaging line.

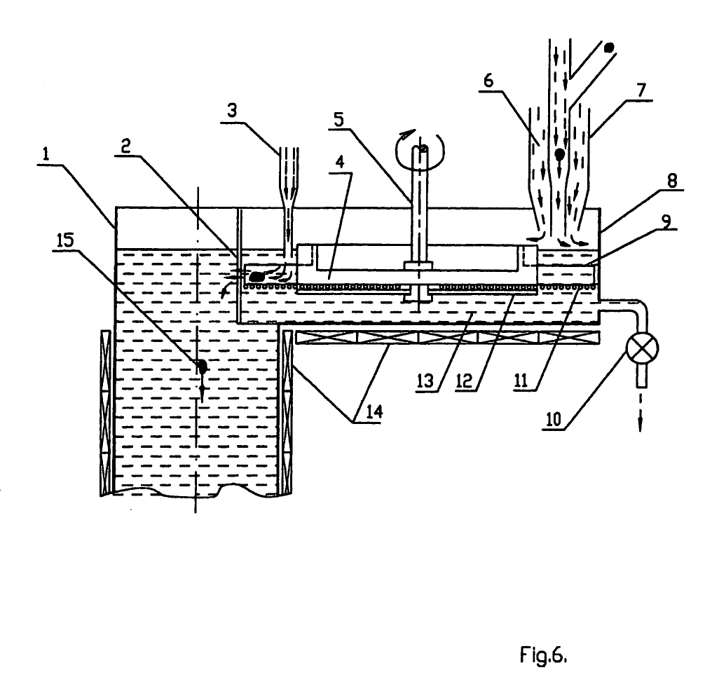

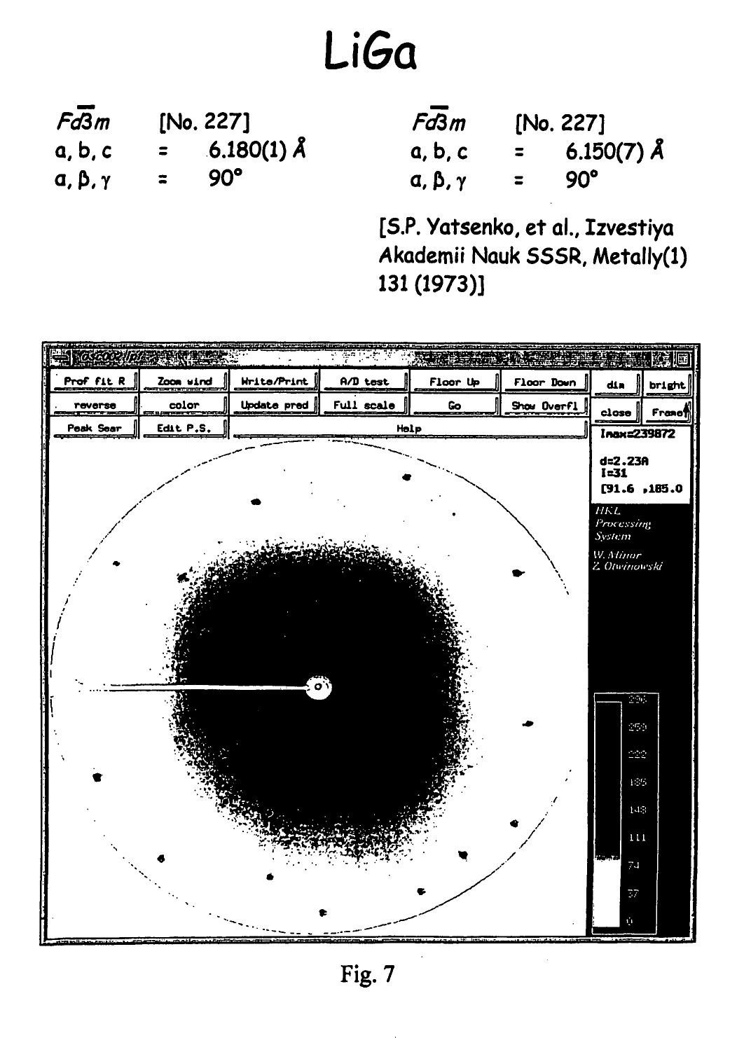

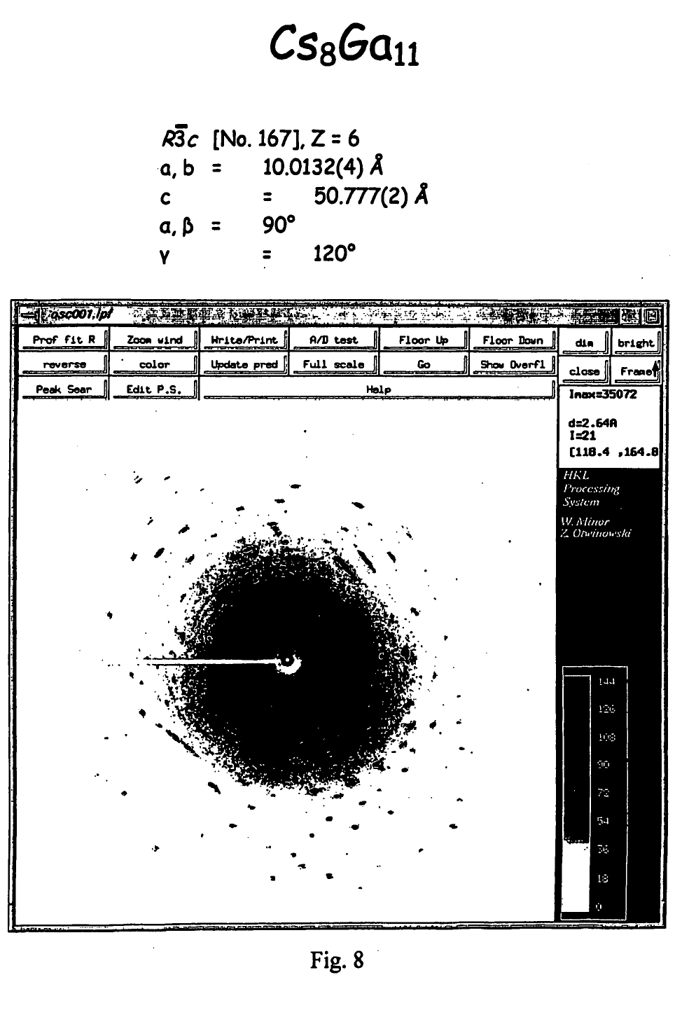

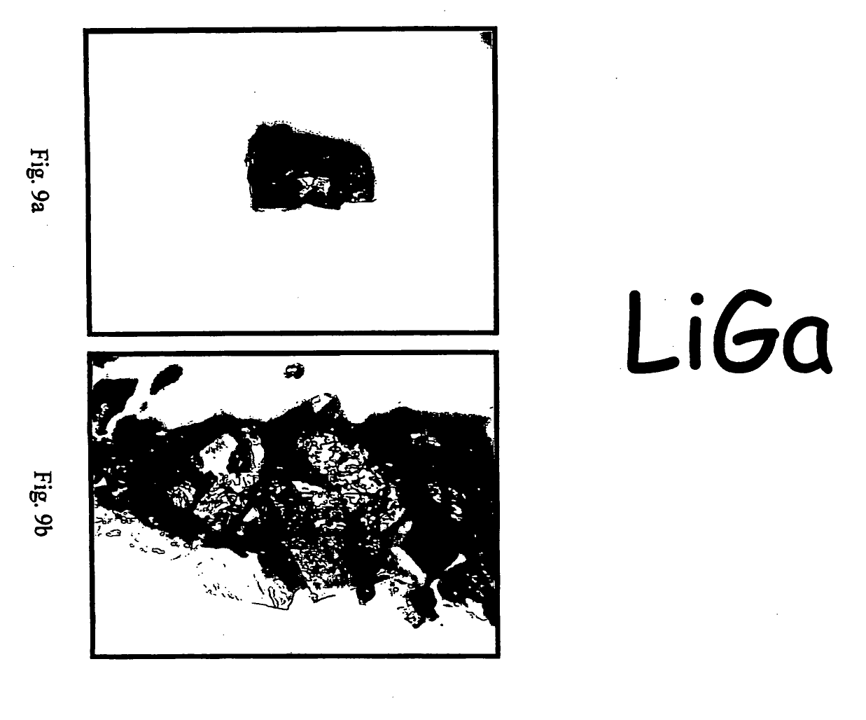

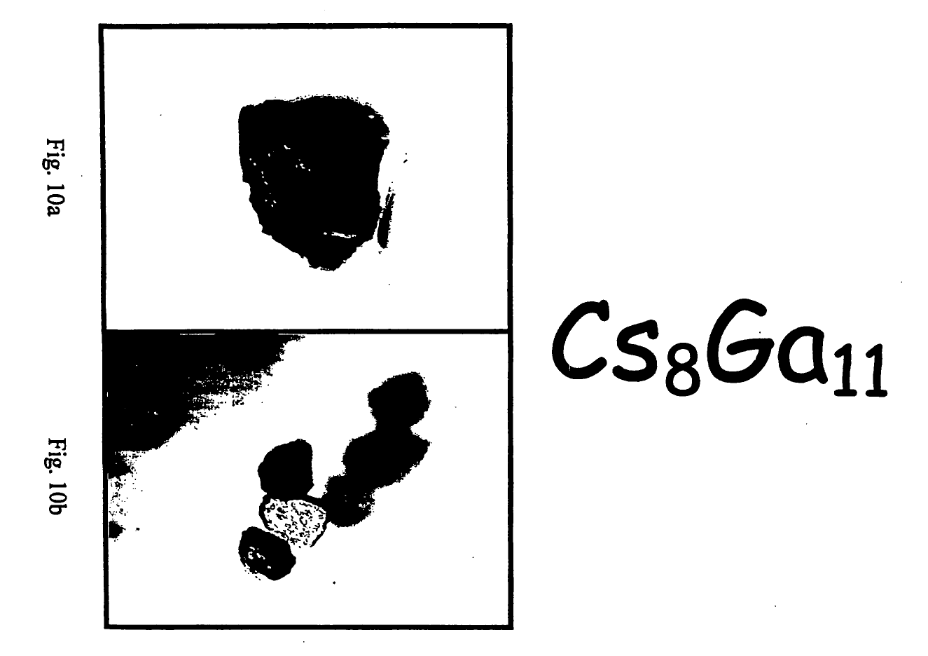

During the process tuning, a doser 5 can be moved along the arc NM and than be fixed. A device for pushing a particle into a column (see 3 in FIG. 6) is not shown here. The packaging line can direct the particles to any of the two positions, A or B. The mesh disk is tightly pressed from below to a plate 4 (FIG. 6), which is fixed to a shaft 27 and connected with a stepper motor 7 as also shown in FIG. 2.

FIG. 6 shows the upper part of the extraction apparatus, wherein the elements in the drawing are identified as follows:

11—an extraction column; 9—a doorway in a bath wall; 33—an injector for wash-off of a particle; 4—a plate; 27—a stepper motor shaft; 23—hot air flows; 21—a doser spout; 2—a bath body; 6—a radial partition; 31—a discharge pipe valve; 4—a mesh; 29—a flat clamping disk; 30—hot water; 14—heaters; 15—a falling particle.

A doser spout 21 is a nozzle with two channels, through which hot air is constantly fed for preventing appearance of condensate on the wall of the inside channel. At the moment when rotation of the plate 4 is stopped the dozer throws the next particle into the bath. During the same stop the injector 33, the lower end of which is always down in hot water, injects the set portion of water, which pushes the particle exposed in the bath into the extraction column.

Partitions 6 are inserted into the radial clearances of the plate, forming the side walls of the cells 8. The outside cylindrical surface of the plate and the inside cylindrical surface of the bath serve as the other borders of the cells.

For convenience of automation, the process time is divided into small alternating intervals Δτₘ and Δτₛ: the plate rotates for Δτₘ seconds, then for Δτₛ seconds it is motionless, and at this stage, during the time Δτₘ, the disk turns to an angle corresponding to an arc Δι (FIG. 2).

The operation of the apparatus is tuned in such a way that by the moment, when a particle is known to acquires a uniform gallium coating, its cell coincides with a doorway 9 in the cylindrical wall of the bath (FIG. 2), then during the stop time Δτₛ this particle is carried to the extraction column (FIG. 6) by a submerged jet, created by an injector 33 (FIG. 6).

Simultaneously, from a doser 21 (FIG. 6) a new particle is thrown into a cell, which is k units away from the cell coinciding with the doorway 9, counting against the direction of the disk movement (FIG. 2). The number k is defined as the nearest integer to k* which is equal to

k*=(T−t)/(Δτₘ+Δτₛ),

where T is the total extraction time, and t is the time of a particle's passing through the hot zone of the extraction column.

FIG. 3 shows a longitudinal section of the apparatus of FIG. 2. The elements in the drawing are identified as follows:

14—a heater, 11—an extraction column, 27—a stepper motor shaft; 4—a plate with a mesh; 31—a discharge pipe; 36—a refrigerator; 7—an internal funnel; 10—a transporter; 39—a conduit; 41—a water inlet; AB—a particle; 43—a shower; 12—a receiving funnel of a rinsing basin; 45—a silicone serpentine tube; 10—a transporter; 17—a guiding collar; 49—a discharge pipe.

A particle is placed on the mesh and pushed with a jet into the column 11, where it falls down with a rate V In a hot zone the resulting force influencing the particle movement is not large. However, a gas jacket serves as an excellent lubrication and the falling rate is sufficiently fast, about 0.1 m/s. In the cold zone, where the viscosity of water increases and the particles lose the gas jacket, their movement is slowed down to the Stokes rate Vs. Here the Ga-shell solidifies. Through the internal funnel 7 the particles get into the moving conveyer 10, and then with its help reach the rinsing basins.

A flexible serpentine tube 45, by compressing or stretching it vertically, allows adjusting the optimum regime for water outlet to maintain an acceptable interval between the particles. The collar 47 retains the particles in the track. Subsequently, the transporter 10 brings the particles to the second rinsing basin, and so on.

The height of the extraction column is 10 to 15 times shorter than in the method proposed previously (RU 2056661 C 1) and does not exceed one meter. As long as a particle is moving through the upper zone, heated by the heater 14 (FIG. 3), it is still reacting with water and has a molten shell. The trajectory of the falling particles is characterized by a certain scattering cone. In order to avoid any touching of a column wall by the particles and damaging the particle's shell, the diameter of the column should be bigger than the base of a scattering cone.

In the lower part of the extraction column, the gallium shell of the particles solidifies in ice-cold water, cooled with the help of an outside cooler 36, and then the particles are focused through an internal funnel 7 to a median of a conveyor belt 10 (FIG. 3). Subsequently the particles are moved up along a belt inclined upwards and to the air. In this process, the liquid taken from the extraction system trickles back and only a very small amount of it is carried together with the particles into the first rinsing basin by a jet 43.

From a funnel 12 the particle with its water cover is moved into a flexible silicone serpentine tube 45 and further onto the conveyor belt 10 (FIG. 3), which brings the particle to the second rinsing basin. This procedure is repeated.

The ratio of fresh running water to the residual liquid, washed off from the conveyor belt into a receiving funnel of the next basin, is approximately 100:1. This setup with a cascade of four basins guarantees a cleaning of the product from metal hydroxides (0 H-anions) to reach lower a pH. In reality the rinsing result is even better, because the concentration of the alkaline solution in the extraction column never reaches 1% due to constant renewal of the water mass in the column (see 31 and 41 in FIG. 3).

The final stage of the process is the drying of the particles. A water jet with particles flows from the last rinsing basin with a rate, the horizontal constituent of which is close to the speed of the mesh belt of the long conveyor 17 (FIG. 2). A row of fans 16 (see also a-a) is installed above the belt, which creates laminar filtered airflows with the temperature kept between 12 and 15° C. At the end of a given line the dry particles arrive at a distributor 18, which either routes the product for charging into the corresponding containers, e.g. boats, or into dust free boxes where they are stored in unpacked form at a temperature not higher than 18-20° C.

Second embodiment according to the present invention: The cassette variant

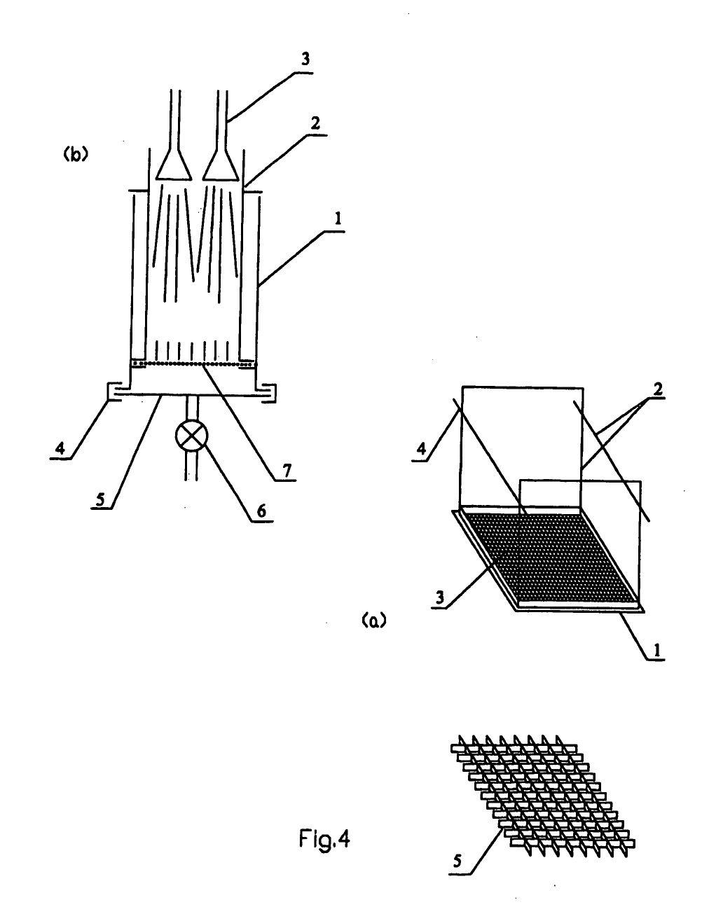

FIGS. 4a, 4b and 4c show the process for rinsing and drying the particles. The elements in the drawings are identified as follows:

a) 101—a sieve in a rectangular frame; 102—a metal carcass; 103—a stainless steel mesh; 104 hooks or protrusions for hanging the sieve in a tank or a bath; 105—honey-combs made of metal foil;

b) 111—a bath; 112—a carcass with a sieve; 113—a shower; 114—clamps; 115—a detachable bottom of a bath; 116—a valve; 117—a mesh with particles.

In FIG. 4b the honey-combs 105 and the sieve 111 are shown separately for better understanding. The detachable bottom of a bath 115 (FIG. 4b) is connected to the lower flange of bath 111 through a sealing gasket with the help of clamps.

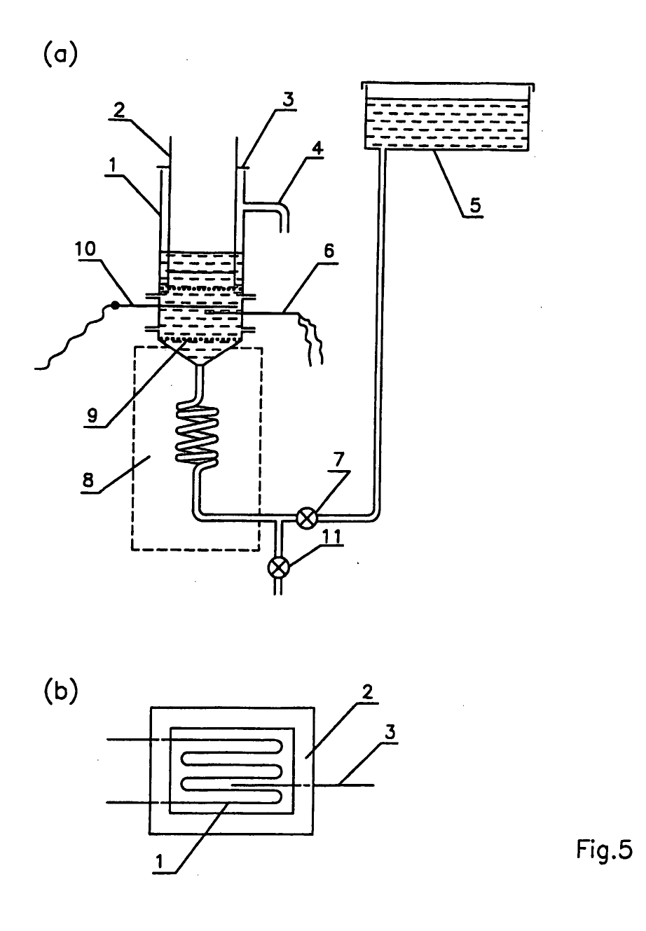

The components for the cassette are shown in FIGS. 5a and 5b. The elements in the drawings are identified as follows:

a) 201—a tank; 202—a carcass with a sieve; 203—hooks, 204—a discharge pipe; 205—a vessel with pure water; 206—a thermocouple; 207—a valve; 208—a refrigerator; 209—a damping mesh; 210—a resistive heater; 211—a valve;

b) 221—a resistive heater; 222—a flange; 223—a thermocouple.

The sieve 202 with the particles is inserted into the tank 201 with heated water and from the moment, when gas bubbles appear, the exposure time starts to be counted off. After the leaching process is over, the valve 207 is opened and ice-cold water replaces the hot water. The hot water is let out through the pipe 204.

A sieve 101 (FIG. 4), consisting of a light carcass 102, mesh 103 and thin-walled honey-combs 105, is charged—in a fume box under n-heptane—with particles of AₙGaₘ. Then this sieve is placed into an extraction tank 201 (FIG. 5a), hanging it on hooks 203 (see also 104 in FIG. 4a). In the part of the tank where the particles are located, water is heated with the help of a low-inertia insulated resistive element 221 in FIG. 5b) up to close to the boiling point. In the lower part of the tank, under the metallic mesh 209, the water has a temperature close to the temperature of melting ice.

The leaching process lasts not longer than 2 minutes, after which a valve 207 is opened and cold water, moving upwards, replaces hot water, which flows out through discharge pipes 204. With the temperature decrease the jacket of gas bubbles, surrounding each particle, starts decreasing and then disappears. Owing to this effect, for maintaining particle floatability the rate of the cold water feed is gradually increased up to the value of ˜Vs (see text to FIG. 3), such that crystallization of the shell of gallium metal takes place without any contact with the mesh.

The time required for the solidification of the shell of gallium metal, the thickness of which usually varies in the range from 10 to 50/lm, does not exceed 2 seconds. Therefore rinsing of the tank with cold water is stopped as soon as the temperature of the water flowing through the pipes 204 reaches about 5° C. The sieve is taken out from the tank and transferred to the washing bath 101 (FIG. 4b). From above a shower 103 is moved to the bath, water is switched on, and the bath is filled to a level that the particles are covered with water. Subsequently, the water is drained through a valve 106, the rinsing procedure is repeated 4-5 times, the shower device 103 is replaced by an air fan for dust free laminar air flow, the bottom 105 of the bath is taken away and drying of the particles is started. After completion of this operation, the particles feature the required degree of purity with respect to residual AOH contaminants, and a passivated gallium coating.

The invention will now be described with reference to specific examples without limiting the invention.

### EXAMPLE 1

For manufacturing encapsulated Cs₈Ga₁₁ particles according to the conveyer variant I, monocrystalline particles of the composition CsgGal1 with an average linear size of 2 mm are charged to a doser 5 (FIG. 2), where they are kept under n-heptane. The water temperature in an extraction bath 2 and in the upper zone of column 1 is set to the range of 96-98° C., the water temperature in the lower zone of the column to about 0° C. Parameters of motion of the mesh disk are: Δτₘ=1 s, ΔTₛ=2 s, T−t=110 s, Δι=6.2 mm. The height of the hot zone of the column is 0.75 m, the height of the hot zone is 0.25 m. The temperature of the running water in the four rinsing basins is about 10° C.

Adhering to the above set of parameters, the capacity of the conveyer line in a steady state regime is about 50 g of encapsulated particles per hour. The final product are particles of Cs₈Ga₁₁ in a shell of gallium metal with the maximum baking temperature of 220° C. and an evaporation temperature for cesium metal of 275° C. and above.

CsGa₃ particles are encapsulated analogously, with the only difference that in this case it is enough to set T−t=80 s. The baking temperature of such a product is not higher than 280° C. and evaporation becomes noticeable starting from 320° C.

### EXAMPLE 2

For manufacturing encapsulated Na₂₂Ga₃₉ particles with an average linear size of 0.8 mm using the cassette variant, monocrystalline Na₂₂Ga₃₉ particles are charged under n-heptane into a sieve with hexangular cells with an edge length of 4 mm. The total number of particles in one charge is about 8.000 items.

The sieve is moved down into a tank with water kept at a temperature of 94-96° C. and the particles are thus exposed to the bath for 75 seconds before they are rinsed with ice-cold water for 2 minutes. Subsequently the particles are rinsed with a shower four times and dried with air as described above for the cassette variant. The whole procedure takes approximately 15 minutes for one load of particles. The capacity of the given method is about 70 g of encapsulated particles per hour. The final product are particles of Na₂₂Ga₃₉ in a shell of gallium metal with a maximum baking temperature of 350° C. and an evaporation temperature for sodium metal of 475° C. and above.

As the water temperature decreases the gas jackets disappear and the floatability of the particles decreases. Therefore the hydraulic thrust load is gradually increased, adjusting the rate of raising the water closer to the value Vₛ, which is defined beforehand for each sort of particles in an auxiliary station. Due to the small thickness of the gallium coating its crystallisation on a crystalline substrate AₙGaₘ in cold water requires only a few seconds. After solidification of the shell the sieve with the particles is lifted for the transfer into a washing bath, and the water from the tank is discharged onto the initial level while the valve 207 is closed and the valve 211 is open. Then the valve 211 is closed and the apparatus is ready for the next process.

1. A method for the production of gallium coated monocrystalline binary intermetallic compounds defined by the general formula
AₙGaₘ
with 0<n≦22 and 0<m≦39, wherein n and m are indices, and wherein compound A is a metal and selected from the group consisting of lithium, sodium, potassium, rubidium, cesium, calcium, strontium, barium, and radium, comprising the steps of:
a) leaching of single crystal particles of the compound of the said formula AₙGaₘ in water, which dissolves metal (A), but which cannot dissolve gallium metal, at a temperature which is higher than the melting point of gallium, to produce on the surface of the particles a melted cover layer consisting essentially of gallium metal,
b) terminating the treatment as soon as the desired thickness of the coating is reached,
c) solidification of the cover layer of gallium metal by cooling the particles to a temperature below the melting point of gallium metal;
d) passivation of the gallium cover layer of the particles.

2. The method according to claim 1, wherein the intermetallic compounds are defined by the general formula AₙGaₘ with 1≦n ≦22 and 1≦m≦39, wherein n and m are stoichometric indices, and wherein A is a metal selected from the group consisting of lithium, sodium, potassium, rubidium, cesium, calcium, strontium, barium, and radium.

3. The method according to claim 1, wherein said steps a), b), c) and d) are carried out with the individual particles isolated from each other to prevent any aggregation.

4. The method according to claim 3, wherein the passivation of the gallium surface layer of the particles according to step d) is carried out in streams of water and/or air.

5. The method according to any of the preceding claim 3, wherein the leaching of step a) of the compound of the formula AₙGaₘ is carried out on a support, especially a mesh.

6. The method according to any of the preceding claims 3, wherein the termination of the treatment in step b) is accomplished by lowering the temperature below the melting point of gallium.

7. The method according to any of the preceding claim 1, wherein the thickness of the gallium coating is 10 11 m or more.

8. The method according to any of the preceding claim 1, wherein the average diameter of the particles of the AₙGaₘ particles is in the range from 0.2 mm to 3.5 mm.

9. The method according to any of the preceding claim 2, wherein mono crystalline particles of the formula AₙGaₘ, grown from a stoichometric melt or from a melt with small excess of gallium, are used as the initial material.

10. The method according to claim 9, wherein monocrystals of compounds of the formula AₙGaₘ selected from the group consisting of LiGa, NaGa₄, Na₂₂Ga₃₉, KGa₃, RbGa₃, CsGa₃, Cs₈Ga₁₁, CaG₄, Ca₃Ga₈, SrGa₄, SrGa₂ and BaGa₄ are chosen in step a).

11. The method according to any of the preceding claim 1, wherein in step a) a particle of the formula AₙGaₘ is exposed to hot water on a slowly rotating horizontal mesh, whereafter the particle is thrown down into a small extraction column wherein in the lower cold part of the column the melted gallium-shell solidifies and the particles get on to a conveyor belt moving the particles to air for rapid passivation, followed by rinsing of the product and drying of the particle with the air-flow.

12. The method according to any of the preceding claim 1, wherein in step a) a metallic sieve divided into a large number of cells is employed to carry the AₙGaₘ particles, which is placed into an extraction tank with hot water and exposed for the set time, displacing subsequently the hot water by cold water from below by feeding cold water upwards through a damping mesh and creating a hydrodynamic backing, which induces crystallisation of a gallium shell under non-contact conditions when a particle is in a suspension state, and where passivation of the created gallium shell by intensive rinsing of particles with distilled water and blowing with dust-free atmospheric air is the final step.

13. Chemically active materials in the form of singular particles of gallium coated monocrystalline intermetallic compounds of the general formula AₙGaₘ with a continuous gallium surface coating for usage in evaporators of metal A with 0<n≦22 and 0<m≦39, wherein n and m are indices, and wherein compound A is a metal and selected from the group consisting of lithium, sodium, potassium, rubidium, cesium, calcium, strontium, barium, and radium, where the average diameter of the particles is in the range from about 0.2 mm to about 3.5 mm, the gallium coating is thicker than 10 μm, and wherein the materials are obtainable by the method according to one or more of the preceding claims 1 to 12.

14. Chemically active materials in the form of singular particles of gallium coated monocrystalline intermetallic compounds of the general formula AₙGaₘ with a continuous gallium surface coating for usage in evaporators of metal A with 1≦n≦22 and 1≦39, wherein n and m are stoichometric indices, wherein compound A is a metal selected from the group consisting of lithium, sodium, potassium, rubidium, cesium, calcium, strontium, barium, and radium, where the average diameter of the particles is in the range from about 0.2 mm to about 3.5 mm, the gallium coating is thicker than 10μ, and wherein the materials are obtainable by the method according to one or more of the preceding claims 1 to 12.

15. Chemically active materials according to claim 13 as a vapor source of alkali and alkaline earth metals in the production of thin films by vacuum deposition.

16. Chemically active materials according to claim 14 as a vapor source of alkali and alkaline earth metals in the production of thin films by vacuum deposition.
